(19) United States
(12) Patent Application Publication
(10) Pub. No.: US 2018/0180004 A1
(43) Pub. Date: Jun. 28, 2018

(54) Common rail distributor rail

(71) Applicant: Nova Werke AG, Effretikon (CH)

(72) Inventors: Christoph Krauter, Konstanz (DE); Steffen Jung, Wängi (CH)

(21) Appl. No.: 15/736,800

(22) PCT Filed: Aug. 24, 2015
(86) PCT No.: PCT/CH2015/000122

§ 371 Date: Dec. 15, 2017

(51) Int. Cl. F02M 55/00; F02M 55/02

(52) U.S. Cl. CPC F02M 55/005; F02M 55/002; F02M 55/025

(57) ABSTRACT

A common rail distributor rail (2) for supplying an internal combustion engine with fuel comprises an inner pressure pipe (3), an outer jacket (4) as well as joint pieces (5) for connecting high-pressure conduits. Thereby, the joint pieces (5) are fixedly connected to the outer jacket (4), in particular by way of thermal joining, and by way of this form a double-walled system with a pressure-tight sealing of the jacket.

The invention relates to the field of the fuel supply of internal combustion engines and in particular to a common rail distributor rail.

Common rail injection systems are used for the fuel supply of internal combustion engines, in particular diesel engines. Such an injection system comprises a distributor rail with a pressure pipe which is fed with fuel by a high-pressure pump via a feed conduit. The distributor rail comprises several branch-pipes which each feed injector conduits for the supply of injection valves of an engine. The injector conduits can be connected with joint pieces to the pressure pipe, wherein typically the injector conduits are screwed to the joint pieces, and the joint pieces are welded to the pressure pipe. A conduit connection of an injector conduit is connected to a pressure pipe connection of the pressure pipe, wherein this connection must withstand the operating pressure of the system

U.S. Pat. No. 4,832,376 shows such a branch pipe, in which a conduit connection is pressed with an outer cone against an inner cone of a pressure pipe. A suitable pressing force is produced by way of a screwing of the conduit connection in a joint piece. The sealing of pressure-leading volumes of the injection system is therefore accomplished by way of cones which are pressed against one another (and not in the region, in which the joint piece embraces the pressure pipe). If the joint piece is fastened to the pressure pipe, then the position of the joint piece in the axial direction of the pressure pipe must be aligned to the position of the inner cone with a high precision. It is therefore advantageous if the joint piece is displaceable on the pressure pipe on connecting the conduit connection.

Concerning ship's engines, the various conduits of the injection system are designed in a double-walled manner, in particular the injector conduits and the distributor rail itself, for reasons of safety. The pressure pipe comprises an outer jacket for this. An exit of fuel can be reliably avoided by way of this. Alternatively or additionally, a fuel excess of the injection valves which inherently occurs on operation can be led back through these intermediate spaces.

Typical operating pressures for the pressure pipe lie above 1000 or above 2000 bar.

Concerning a double-walled distributor rail, the problem of connecting the injector conduits which are subjected to high pressure, onto the pressure pipe, as well as of designing the intermediate space in a pressure-resistant manner arises. Suitable joint pieces must therefore connect the injector conduits onto the pressure pipe in a pressure-tight manner, as well as be connected onto the jacket in a pressure-tight manner.

In known systems, a pipe piece as part of the jacket is inserted between two joint pieces and sealed with respect to the joint pieces by way of sealing elements, for example O-rings. The entirely of such pipe pieces and the joint pieces forms the jacket. On assembly of the distributor rail, an axial position of the joint pieces along the pressure pipe can be adapted to the axial position of the pressure pipe connections due to the jacket being of several parts and the joint pieces permitting a certain axial play of the pipe pieces. However, the disadvantage here is the fact that the parts do not find their definitive position to one another until the assembly of the distributor rail on the engine, and moreover only then can the pressure resistance of the jacket be examined.

It is therefore a possible object of the invention to provide a common rail distributor rail which overcomes the disadvantages mentioned above.

A further possible object is to provide a common rail distributor rail which is can be simply assembled and transported.

A further possible object is to provide a common rail distributor rail which is double-walled and with regard to which an outer jacket can be tested for sealedness already before an assembly on an engine, for whose operation the distributor rail is provided, and the sealedness is retained up to assembly on the engine and after assembly on the engine.

A further object is to provide a common rail distributor rail which is simply and therefore inexpensively manufacturable as a unique piece or in small series.

A further object of the invention is to provide a common rail distributor rail which is double-walled and permits a reliable assembly of connections on an inner pressure pipe.

A further possible object is to provide a common rail distributor rail which is simple to repair, in particular given damage to a leakage pipe.

At least one of these objects is achieved by a common rail distributor rail according to at least one of the patent claims.

A common rail distributor rail for supplying an internal combustion engine with fuel, according to a first aspect of the invention comprises an inner pressure pipe, an outer jacket as well as joint pieces for connecting high-pressure conduits such as injector conduits. Here, the joint pieces are fixedly connected to the outer jacket, in particular by way of thermal joining, and form a sealing of the jacket by way of this.

With this, the parts of the jacket are no longer inserted into the joint pieces and sealed with O-rings, but form a fixed connection with the joint pieces. The mentioned parts of the distributor rail—the pressure pipe, the jacket pipe and joint pieces—form a firm (fixed) overall structure. This is firm per se with respect to all six (translatory and rotatory) degrees of freedom. The distributor rail can be manufactured, tested, transported and assembled as a unit. In particular, a test for sealedness at a certain pressure, for example 200 bar, is possible on manufacture and can then be considered as being secure—in contrast to a jacket which is not formed until assembly on the engine and until the assembly of the individually parts of the jacket which this entails.

Here and at other places, one speaks of high-pressure conduits. However, it is to be understood that other high-pressure components such as e.g. flow limiters or pressure sensors can also be connected.

Biting edges sealings can be present as connection partners between the pressure pipe and connection conduits, for example injector conduits, due to the fact that the jacket pipe with the joint pieces is intrinsically stiff, thus does not permit a mutual displacement of these elements. Concerning such biting edge sealings, one side of such a connection can be a plane surface, so that the mutual position of the connection partners, in particular in the axial direction of the pressure pipe, is not defined by the connection. The position of the joint pieces is defined by the fixed connection to the jacket pipe, so that the position does not need to be defined by the connection to the pressure pipe.

The axial direction of the pressure pipe can also be called the longitudinal direction of the pressure pipe and is identical to the axial direction or longitudinal direction of the jacket as well as of the distributor rail as a whole.

Thermal joining in particular includes welding or soldering. The joint pieces can also be bonded to the jacket as an alternative to thermal joining.

According to an embodiment, the joint pieces each have circumferential joining locations to the jacket.

In particular, the joint pieces are therefore each circularly welded or circularly soldered to the jacket. This means that a weld seam or solder location which runs essentially circularly along the circumference of the jacket is present between the joint piece and the jacket at both sides of the joint piece.

This results in no additional parts being necessary for the sealing. A pressure-tight sealing is created between the jacket and the joint piece on creating the joining location. This sealing can be tested for sealedness, wherein the sealedness is also ensured after transport and assembly of the distributor rail.

The jacket or the intermediate space here must remain sealed at pressures of for example 200 bar to 500 bar (in the intermediate space).

The pressure pipe itself is not welded. Its sealedness is not compromised on account of this. The materials for the jacket pipe and the joint piece can be selected according to optimal welding characteristics.

According to an embodiment, the jacket is formed by a continuous jacket pipe.

A single jacket pipe therefore carries essentially all joint pieces. A simple and stable design of the distributor rail is ensured by this. The jacket pipe is self-supporting and is not reliant on the support by the pressure pipe and joint pieces.

The pressure pipe to a large extent can be mounted in the jacket pipe in a “floating” manner. It can be distanced to this by way of spacer elements. Such spacer elements can be inserted spacer discs, spacer rings, inwardly directed webs of the jacket pipe (profiled jacket pipe) and/or outwardly directed webs of the pressure pipe (profiled pressure pipe). An intermediate space for leading away leaking fuel remains between the spacer elements. In the case of webs as spacer elements, the intermediate space is formed by grooves which lie between the webs.

The intermediate space provides an essentially constant leakage cross section over the length of the distributor rail—in contrast to a design with individual jacket pipe sections which are each inserted into joint pieces. Above all, this is advantageous on leading away injector leakage, thus with the return feed of a control quantity from the injection nozzles.

A mutual fixation between the pressure pipe and the jacket pipe is effected via inserted high-pressure conduits or their connections to the pressure pipe. Alternatively or additionally, the mutual fixation can be effected by way of at least one fixation element. This can clamp the pressure pipe and the jacket pipe against one another, for example by way of the fixation element being designed for example as a screw which rotates in a thread in a joint piece and presses against the pressure pipe. Here, a connection which centres itself, for example by way of cones on the screw and pressure pipe and which fit into one another can be present.

According to an embodiment, the jacket is formed by a row of individual pipe pieces which are each connected to one another by the joint pieces. Here, the distributor rail can also be manufactured by way of welding the joint pieces to the pipe pieces of the jacket pipe, by which means a fixed total structure having the already described characteristics arises.

According to an embodiment, pressure pipe connections which are envisaged for connection to a high-pressure conduit by way of a biting edge sealing are formed on the pressure pipe.

Here for example, a pressure pipe connection comprises a plane surface, against which a biting edge of a conduit connection of a high-pressure conduit can be pressed. However, a biting edge can conversely also be formed on the pressure-pipe connection, and a corresponding surface on the conduit connection.

Concerning a sealing which is realised with a biting edge (biting edge sealing), sealing surfaces of two metallic component which bear against one another comprise a ridged or bead-like prominence, which on tightening the components to one another leads to a sealing, plastic deformation along the prominence.

A cone connection or lens-like connection between the conduit connection and the pressure pipe connection can alternatively be present.

Concerning a cone connection, a precise tolerance between the pressure pipe connections on the pressure pipe and the welded-on joint pieces must be maintained, and specifically over the entire length of the distributor rail, wherein such a length can be more than 5 m in the case of larger engines.

A common rail distributor rail for the supply of an internal combustion engine with fuel, according to a second aspect of the invention which can be realised in combination with the other aspects but also independently of the other aspects comprises an (inner) pressure pipe as well as joint pieces for the connection of high-pressure conduits. Here, the joint pieces are also manufactured by way of cutting from a flat material. Optionally, the common rail distributor rail can also comprise an outer jacket.

A manufacture of joint pieces of a different shape which—in contrast to cast pieces—is flexible, becomes possible by way of this. Joint pieces can be fashioned and manufactured in an order-specific and inexpensive manner in accordance with customer demands, for distributor rails in small series and as individual pieces. The flat material can be a metal plate, in particular a steel plate, with a maximal thickness for example of 4 cm to 8 cm or more. An individual joint piece can be manufactured from a plate with a thickness of for example between 2 cm and 4 cm, and a double joint piece from 7 cm to 15 cm thick material. As a whole, joint pieces can therefore have a thickness of 2 cm to 15 cm.

The cutting-out can be effected for example by way of water jet cutting, laser cutting or torch cutting. The plane of the flat material, from which the joint piece is cut runs normally to the axial extension direction of the distributor rail, of the pressure pipe and of the jacket. Moreover, improved material characteristics of the joint pieces can achieved by way of the use of a rolled steel instead of cast steel, said improvements for example being a better (notch) impact strength, elongation at break, machinability, weldability, no casting errors, etc. Pieces which are cut out in such a manner can be blanks which are post-machined into the final shape of the joint pieces.

The joint pieces can alternatively be manufactured by way of:
Manufacturing a profile rod with a contour which corresponds to the contour of the joint pieces in the axial direction of the distributor rail. This can be effected for example by way of extruding. The profile rod in this case is an extruded body.
Cutting off pieces of the profile rod into blanks with a length which corresponds to a desired length of joint pieces in the axial direction of the distributor rail.
Post-machining the blanks into the final shape of the joint pieces.

Joint pieces with high series numbers can be inexpensively manufactured by way of this.

According to an embodiment, the joint pieces comprise elements for fastening the joint pieces and therefore the distributor rail, on an engine.

The joint pieces in this case thus have a double function, by way of then forming the connections of the high-pressure conduits as well as serving for the fastening of the distributor rail on the engine. The joint pieces can comprise further assembly elements which are specific to the application, for example for fastening a covering, cables or cable channels.

According to an embodiment, at least one of the joint pieces is manufactured from a flat material with a different thickness than the other joint pieces, in particular with at least double the thickness than the other joint pieces.

The extension of the joint piece in the axial direction of the distributor rail can be simply determined by the selection of the thickness of the flat material, thanks to the manufacture of the joint pieces from flat material. A joint piece with a greater extension than others can be used for the connection of several pressure conduits (feed and/or outgoing) and/or for connection to other elements.

Moreover, joint pieces can be inexpensively manufactured in different shapes by way of correspondingly different contours being cut out of the flat material. Thus the distributor rail can comprise joint pieces which have a different shape considered in the projection along the longitudinal direction or the axial direction of the distributor rail.

If the joint pieces are manufactured by way of cutting away from a profile rod, then analogously at least one joint piece can be manufactured by way of cutting off a piece of the profile rod in a first length which is different to the length of other joint pieces. In particular, the first length is at least twice the length of other joint pieces. The length is thereby measured along the longitudinal direction of the profile rod. This direction concerning the joint piece corresponds to the longitudinal direction of the distributor rail in the assembled condition.

A common rail distributor rail for the supply of an internal combustion engine with fuel, according to a third aspect of the invention which can be realised in combination with the other aspects but also independently of the other aspects comprises an inner pressure pipe, an outer jacket as well as joint pieces for connecting high-pressure conduits. Here, a section of the pressure pipe, in particular at least one end of the pressure pipe, and one of the joint pieces are positively connected to one another and this positive connection forms a rotation lock of the pressure-pipe with respect to this joint piece.

Alternatively or additionally, the pressure pipe and the joint piece can also be non-positively connected to one another at a location other than at one end, and the rotation lock formed by way of this.

A rotation of the pressure pipe is prevented by this, if for example a conduit which is screwed axially to the pressure pipe, or a seal pipe connection need to be screwed to the pressure pipe. A rotation lock can also be arranged at only one end or at both ends of the distributor rail. In the case that two rotation locks are present, then the one can be designed such that it permits a displacement of the pressure pipe and the joint piece in the axial direction, and the other such that it does not permit such a displacement.

The rotation lock can be realised by way of a suitable shaping of the pressure pipe and the joint piece, for example by way of a flattened location which lies on the circumference of the pressure pipe, or by way of a prismatic shape of the pressure pipe and the inner side of the joint piece. Alternatively or additionally, a groove can each be present in the pressure pipe and the joint piece, into which groove a feather key is inserted.

The rotation lock can be designed for a tightening torque of up to 200 Nm.

According to an embodiment, a fixation element which eliminates a play of the rotation lock is present.

The fixation element eliminates a possible, still remaining play of the rotation lock, by way of it clamping the pressure-pipe against the joint piece. This can be effected in a variety of manners, for example by way of a wedge or a fixation screw which is led in the joint piece and is screwed against the pressure pipe.

A further fixation element which fixes a mutual position between at least one joint piece and the pressure pipe in the axial direction can be present. This axial fixation can also be realised by the identical fixation element which eliminates the play of the rotation lock.

A common rail distributor rail for supplying an internal combustion engine with fuel, according to the fourth aspect of the invention which can be realised in combination with the other aspects but also independently of the other aspects comprises an (inner) pressure pipe as well as joint pieces for connecting high-pressure conduits. Here, a continuous leakage pipe for leading away flowing-back fuel is present. Optionally, the common rail distributor rail can also comprise an outer jacket.

Such a leakage pipe serves for example for receiving a backflow of fuel from the injection valves (injector backflow) which is inherent of the principle. The fuel can be delivered through individual return conduits, where these can also lead to the leakage pipe through the joint pieces themselves or lead directly into the leakage pipe.

The presence of a continuous leakage pipe permits a simple assembly and disassembly of this, and it can be fastened such that the assembly/disassembly is possible without having to disassemble the joints and therefore the complete distributor rail—this is in contrast to systems, in which a leakage conduit consists of several part-sections which each lead for joint piece to joint piece and are inserted into the joint pieces. The leakage pipe can therefore be simply exchanged if it becomes damaged.

According to an embodiment, the leakage pipe is fastened with hollow connecting elements to the joint pieces, wherein these connecting elements are each provided to lead back-flowing fuel into the leakage pipe.

Connecting elements for example are hollow screws or hollow rivets. The connecting elements thus serve for fastening the leakage pipe as well as also the feed conduit. The leakage pipe can also be welded or soldered to the joint pieces, wherein however one must prevent the distributor rail from deforming. Alternatively, the leakage pipe can be bonded to the joint pieces.

According to an embodiment, the leakage pipe is a profile tube, in cross section comprises at least one flat wall section and with this flat wall section is assembled against the joint piece. In particular, the league pipe is thereby a square pipe.

Simply designed sealing locations to the leakage pipe can thus be realised by way of the flat wall section being assembled against a flat part of the joint piece, and a sealing element, for example a sealing ring, being arranged between the two parts.

Typically, the leakage system and in particular the leakage pipe and the connected conduits are designed for a pressure strength of up to 50 bar.

Further preferred embodiments are to be derived from the dependent patent claims.

The subject-matter hereinafter described in more detail by way of preferred embodiment examples which are represented in the accompanying drawings. In each case are schematically shown in:

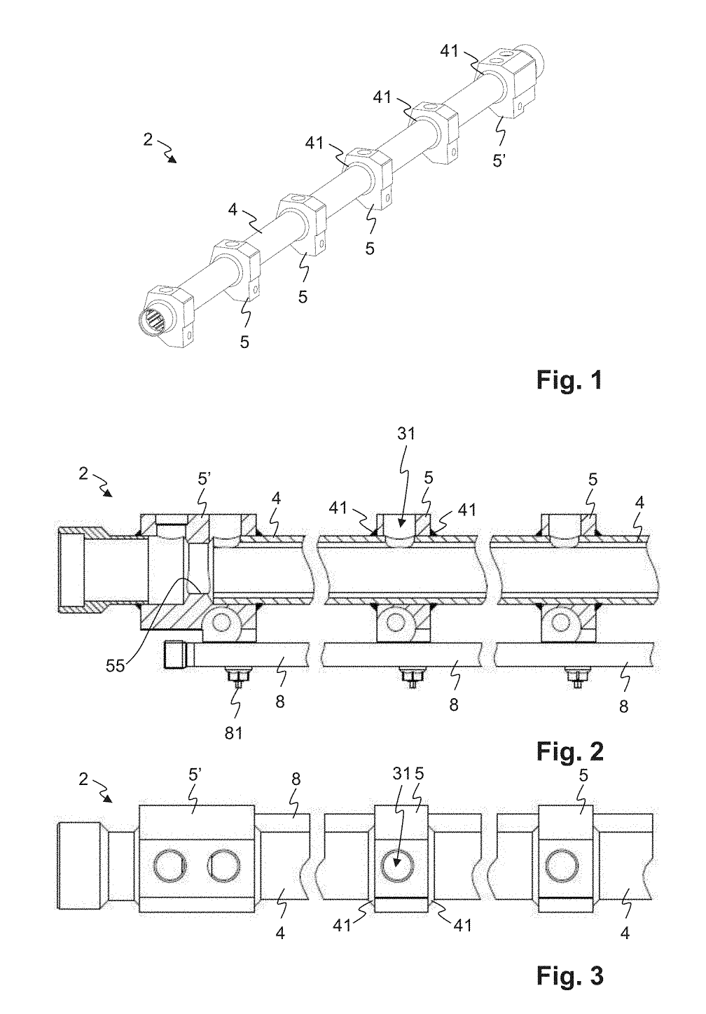

FIG. 1 a view of a distributor rail;

FIG. 2 a longitudinal section through an end of the distributor rail with a pressure pipe and jacket pipe;

FIG. 3 a plan view of the end of the distributor rail;

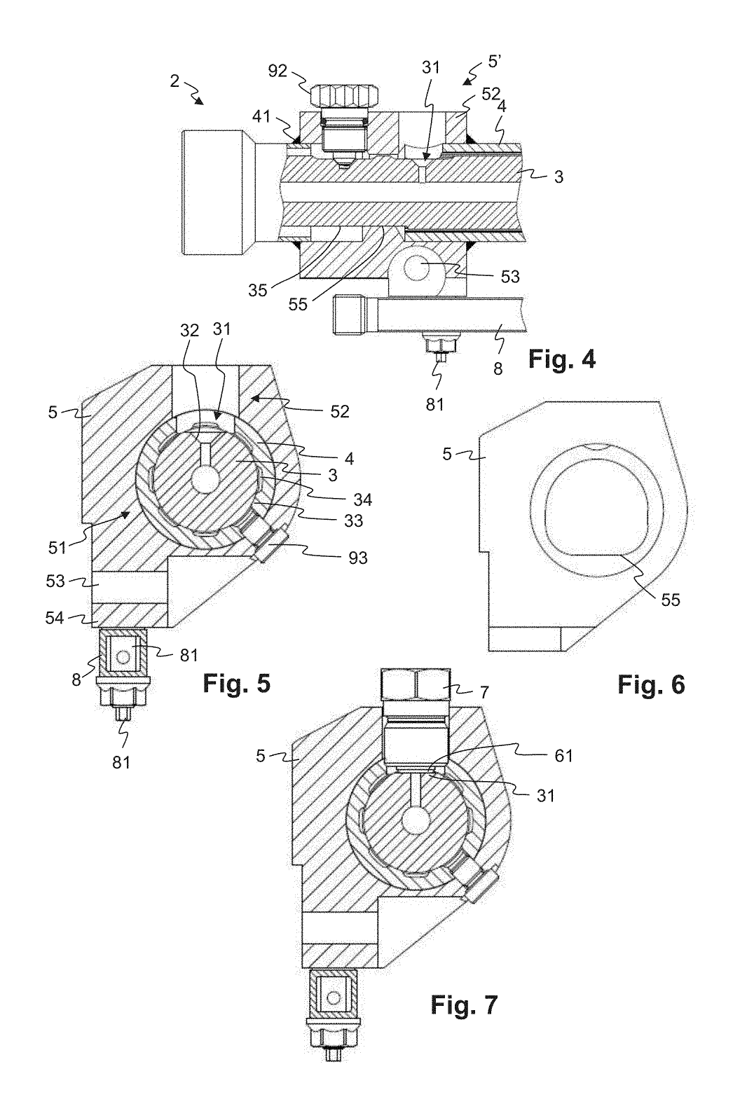

FIG. 4 a longitudinal section through one end of a distributor rail with a pressure pipe and jacket pipe and further elements;

FIG. 5 a cross section through a distributor rail in the region of a joint piece, with a conical connection;

FIG. 6 a cross section through a joint piece in the region of a rotation lock; and

FIG. 7 a cross section through a distributor rail in the region of a joint piece, with a connection with a biting edge.

Basically, in the figures the same parts are provided with the same reference numerals

FIG. 1 shows a view of a distributor rail 2. What is visible is a jacket pipe 4 with joint pieces which are rowed thereon. The joint pieces 5 are each welded with round weld seams 41 to the jacket pipe 4 in a manner following the circumference of the jacket pipe 4. The jacket pipe 4 can be of one part over the complete length of the distributor rail 2, or however be designed as a multi-part jacket, wherein individual part-sections of the jacket each reach from one joint piece 5 to the adjacent joint piece 5 or also up to a more remote joint piece 5. Here, the joint pieces 5 serve for connecting pressure conduits as well as for fastening the distributor rail 2 to the engine (not shown).

FIG. 2 shows a longitudinal section through sections of the distributor rail 2 and FIG. 3 a plan view of these. A pressure pipe which runs in the jacket pipe 4 is not shown for reasons of clarity. Apart from the already described elements, pressure pipe connections 31, at which departing high-pressure conduits (injector conduits) are connectable to the pressure pipe 3 are yet visible.

A rotation lock 55 is arranged in the region of a double joint piece 5′ which is arranged to the left in the picture. Here, the rotation lock 55 is designed as a flattened part of the circular circumference of the opening for the pressure pipe. FIG. 6 shows the rotation lock 55 in view (in the axial direction) of the double joint piece 5′ on its own. The rotation lock 55 with a correspondingly shaped flattened region of the pressure pipe 3 forms a positive connection and fixes a rotation position of the pressure pipe 3 with respect to the double joint piece 5′.

FIG. 4 shows a further longitudinal section through an end of a distributor rail 2 with a pressure pipe 3 and a jacket pipe 4 and further elements which are connected onto the distributor rail 2. Double-walled injector conduits or high-pressure conduits or other components such as e.g. flow limiters or pressure sensors etc. can be connected to each of the joint pieces 5 via intermediate pieces 7 (FIG. 7). Inner pressure-conduits of the high-pressure conduits are connected onto the pressure-pipe 3 in a pressure-tight manner by way of cone connections. A feed conduit is likewise connectable onto the pressure-pipe 3 via a cone connection. The high-pressure conduits and feed conduits are not considered as part of the distributor rail 2.

The pressure pipe 3 comprises an upper flattened region with a pressure pipe connection 31, and a lower flattened region 35 which interacts with the flattened region of the rotation lock 55 on the joint piece and thus realises the rotation lock.

The jacket pipe 4 here, up to the very left, is represented in a continuous manner. If, as is shown in FIG. 2, the double joint piece 5′ also comprises the rotation lock 55 which indeed is formed on a narrowing which reaches inwards up to the pressure-pipe 3, then the continuous jacket pipe 4 would reach from the right only up to this narrowing. The short section of the jacket which remains to the left of the narrowing is then formed by a separate pipe piece which is typically likewise welded to the double joint piece 5′.

FIG. 5 shows a cross section through a distributor rail 2 in the region of a joint piece 5. Visible here, apart from the already described elements, are:
A pipe region 51, at which the joint piece 5 is in connection with the jacket pipe 4. A cross section of the jacket pipe 4 is visible in this, with inwardly directed webs 33 for spacing the pressure pipe 3, and with corresponding grooves 34 for forming an intermediate space.
A connection region 52, at which a high-pressure conduit can be connected onto the joint piece 5 via an intermediate piece 7. Here, a conduit connection 61 of the high-pressure conduit can be pressed with an outer cone against a pressure pipe connection 31 of the pressure pipe 3 with an inner cone 32. On the one hand, the intermediate piece 7 presses the conduit connection 61 against the pressure pipe connection 31, and on the other hand forms a transition intermediate space between the intermediate space of the pressure pipe 3 and jacket pipe 4 and an intermediate space of the inner pipe and outer pipe of the high-pressure conduit.
A fastening region 53 for fastening the joint piece 5 to an engine or to another carrier object.
A leakage pipe carrier 54 for fastening a leakage pipe 8. This leakage pipe can receive fuel which is from the injection valves and which flows back via (non-drawn) return conduits, and leads it further back to the fuel source. The leakage pipe 8 is assembled on the leakage pipe carrier 54 by way of a hollow screw 81, optionally with sealing elements between the hollow screw 81 and the leakage pipe carrier 54, in the case that the sealing effect of the screw thread is insufficient. The leakage pipe carrier 54 can be shaped out as one piece on the joint piece 5. Fuel flows through the return conduit into the hollow screw 81 and through a bore on the circumference of the hollow screw 81 into the leakage pipe 8.

A closure element 93, here in the form of a screw, can be opened in the case of a service, and thereby be used for restricting the location of a leakage.

FIG. 7 shows a cross section through a distributor rail 2 in the region of a joint piece 5, similarly to FIG. 5. Apart from the already described elements, here a connection with a biting edge is represented instead of a cone connection: a conduit connection 61 of the high-pressure conduit is designed as a biting edge and is pressed against a plane surface on the connection region 31 of the pressure pipe 3 by way of the intermediate piece 7 which for example is screwed to the joint piece.

1. A common rail distributor rail (2) for supplying an internal combustion engine with fuel, comprising an inner pressure pipe (3), an outer jacket as well as joint pieces (5) for connecting high-pressure conduits,
characterised in that
the joint pieces (5) are fixedly connected to the outer jacket, in particular by way of thermal joining, and form a sealing of the jacket by way of this.

2. A distributor rail (2) according to claim 1, wherein the joint pieces (5) each comprise circumferential joining locations (41) to the jacket.

3. A distributor rail (2) according to claim 1, wherein the jacket is formed by a continuous jacket pipe (4).

4. A distributor rail according to claim 1, wherein the jacket is formed by a row of individual pipe pieces which are connected to one another by the joint pieces (5).

5. A distributor rail (2) according to claim 1, wherein pressure pipe connections (31) are formed on the pressure pipe (3) and are provided for connection to a high-pressure conduit by way of a biting edge sealing, in particular by way of a pressure pipe connection (31) comprising a plane surface, against which a biting edge of a conduit connection (61) of a high-pressure conduit can be pressed.

6. A distributor rail (2) according to claim 1, wherein the joint pieces (5) are manufactured by way of cutting out from a flat material or by way of cutting off from a profile rod.

7. A distributor rail (2) according to claim 6, wherein the joint pieces (5) comprise elements (53) for fastening the joint pieces (5) and thus the distributor rail (2) to a motor.

8. A distributor rail (2) according to claim 6, wherein at least one of the joint pieces (5) is manufactured from a flat material with a different thickness than the other joint pieces (5), in particular with at least double the thickness than the other joint pieces (5)

9. A distributor rail (2) according to claim 6, wherein at least one of the joint pieces (5) is manufactured by way of cutting off a piece with a first length from the profile rod, and this first length is a different length than the other joint pieces, in particular at least twice the length of other joint pieces (5).

10. A distributor rail (2) according to claim 1, wherein at least one section, in particular an end of the pressure pipe (3) and one of the joint pieces (5) are positively and/or non-positively connected to one another and this positive connection forms a rotation lock of the pressure pipe (3) with respect to this joint piece (5).

11. A distributor rail (2) according to claim 10, wherein a fixation element (92) is present, said fixation element eliminating a play of the rotation lock.

12. A distributor rail (2) according to claim 1, wherein a further fixation element is present, said further fixation element fixing a mutual position between at least one joint piece (5) and the pressure pipe (3) in the axial direction, and wherein in particular the further fixation element is identical to a fixation element (92) which eliminates a play of the rotation lock.

13. A distributor rail (2) according to claim 1, comprising a continuous leakage pipe (8) for leading away back-flowing fuel, said leakage pipe running parallel to the pressure pipe (3) and being fastened to the joint pieces (5).

14. A distributor rail (2) according to claim 13, wherein the leakage pipe (8) is fastened with hollow connecting elements (81) to the joint pieces (5), wherein these connecting elements (81) are each envisaged to lead back-flowing fuel into the leakage pipe (8).

15. A distributor rail (2) according to claim 13, wherein the leakage pipe (8) is a profile pipe, in cross section comprises at least one flat wall section and is assembled with this flat wall section against the joint piece (5), in particular wherein the leakage pipe (8) is a square pipe.
